(19) United States
(12) Patent Application Publication
(10) Pub. No.: US 2003/0201367 A1
(43) Pub. Date: Oct. 30, 2003

(54) Process for the recovery of the energy from the air in pressurised areas of aircraft

(76) Inventor: Manuel Munoz Saiz, Madrid (ES)

Correspondence Address: Robert M. Schwartz, RUDEN, McCLOSKY, SMITH,, SCHUSTER & RUSSELL, P.A., 200 EAST BROWARD BOULEVARD, Fort Lauderdale, FL, 33301, US

(21) Appl. No.: 10/215,733

(22) Filed: Aug. 9, 2002

(30) Foreign Application Priority Data
Apr. 24, 2002 (ES) P200200957

(51) Int. Cl. B64C 21/04; B64C 3/00

(52) U.S. Cl. 244/207

(57) ABSTRACT

A process for the recovery of the energy from the air in pressurised areas of aircraft that involves linking or moving air from the pressurised areas to the lower areas of the fuselage or lower surfaces of the wings, the horizontal stabilisers, and other aerodynamic profiles, along ducting and/or by discharging through multiple slots or openings flowing downward and rearward with a small inclination against the direction of the air flow, to avoid turbulence. The pressure of the pressurised cabin air conditioning is used. In other cases, it is used the pressure produced at the front of the fuselage, on the leading edges of the wings, the horizontal stabiliser or other aerodynamic profiles. Lift is increased in all cases without further energy requirements.

### CROSS REFERENCE TO RELATED APPLICATIONS

This patent claims the priority date of Spanish Patent P200200957 filed on Apr. 24, 2002. The basis for priority in this case is the Paris Convention for the Protection of Industrial Property (613 O.G. 23. 53 Stat 1748) The Spanish patent application was filed in the Official Patent and Trademark Office of Spain.

### BACKGROUND OF THE INVENTION

1. Field of the Invention

Recovery of energy from the air conditioning and pressurised areas of aircraft, such as the front of the fuselage, wings and horizontal stabiliser.

2. State of the Prior Art

At present, aircraft air conditioning is ejected to the exterior through airflow outlet valves without taking advantage of the pressure or potential energy in relation to the exterior of the aircraft caused by the flow of air required for its renewal, very high in current designs. Nor is the pressure used which is created in the frontal areas of the fuselage and the wing leading edges and horizontal stabiliser. There are only systems which feed this air flow back to the engine turbine inputs, and others which operate mechanical, hydraulic and other devices.

### DESCRIPTION OF THE INVENTION

The process for the recovery of the energy from the air in pressurised areas of aircraft involves linking or moving air from the pressurised areas to the lower areas of the fuselage or lower surfaces of the wings, the horizontal stabilisers, and other aerodynamic profiles, along ducting and/or by discharging through multiple slots or openings flowing downward and rearward with a small inclination against the direction of the air flow, to avoid turbulence. Lift is increased in all cases without further energy requirements.

The pressure of the pressurised cabin air conditioning is used. Here, part of the air can be discharged into the air by a duct through a valve regulating the air flow, while the rest of the air can be discharged directly through other openings or slots without flowing through that valve.

In other cases, it is used the pressure produced at the front of the fuselage, on the leading edges of the wings, the horizontal stabiliser or other aerodynamic profiles.

With the air flow or the increased pressure and/or density in the lower areas of the various elements, or in the reaction experienced, total aircraft lift, and therefore performance, is increased.

The opening or groove outlets may take the form of converging nozzles.

Advantages: This system takes advantage of the high energy of the air conditioning and other pressurised areas of aircraft, such as the front of the fuselage, wings and horizontal stabiliser in relation to the exterior. It does not require moving parts and it is simple and economical.

### BRIEF DESCRIPTION OF THE DRAWINGS

FIG. 1 shows a partial, schematic and cross-section of a fuselage and a wing with the device of the invention.

FIG. 2 to 4 show several schematic and cross-section profiles with the pressure distribution.

### MORE DETAIL DESCRIPTION OF THE DRAWINGS

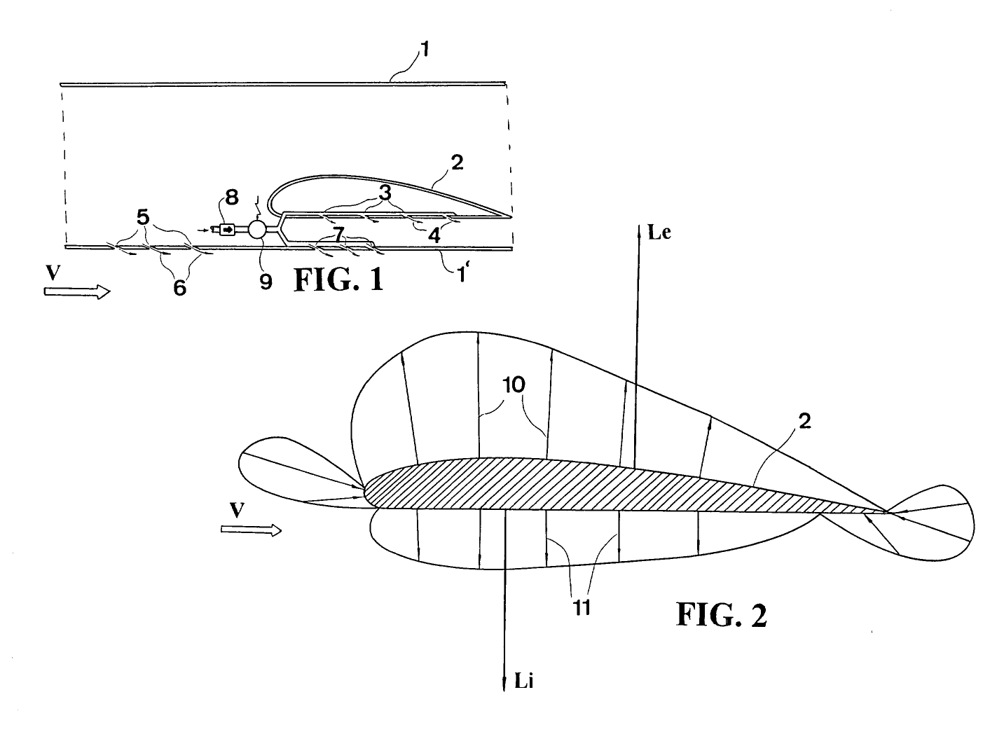

FIG. 1 shows the fuselage (1 and 1′) with slots or openings (5) that allow flowing (6) from the pressurised cabin, the rest of the cabin air is sent through a check valve (8) and a regulating valve (9), the flow (4) is discharged through multiple slots and openings (3) of the wing intrados (2) and through slots and openings (7) of the lower areas of the fuselage.

FIG. 2 shows the wing (2) with the pressure distribution, where the extrados vectors (10) have the resultant (Le) and the intrados vectors (11) the resultant (Li). It shows the profile of a current wing without the invention arrangement. (V) is the ram air.

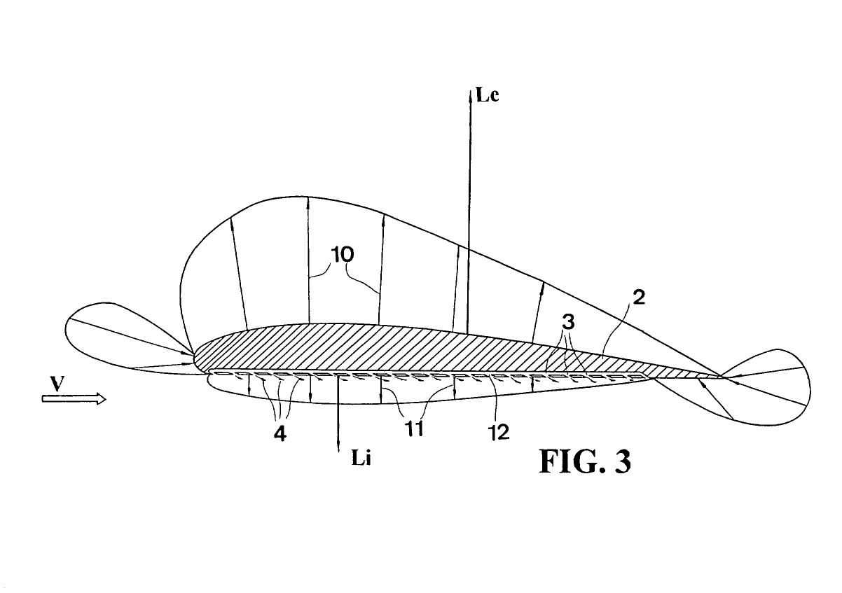

FIG. 3 shows the wing (2) discharging the air flow (4) through slots and openings (3) of the intrados with the pressure distribution where the vectors (10) of the extrados have the resultant (Le) and the intrados vectors (11) the resultant (Li), this of less value than the current wing shown in FIG. 2, thus increasing its lift. (V) is the ram air.

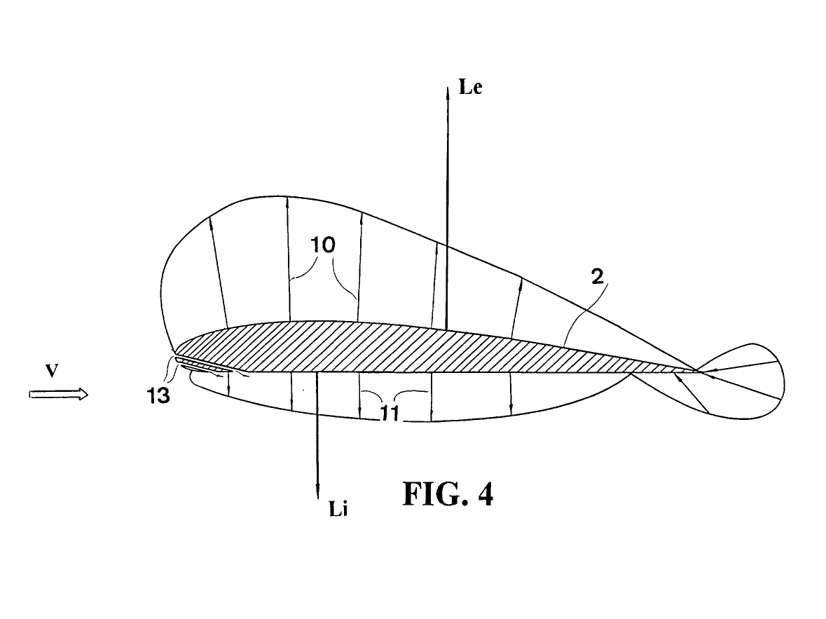

FIG. 4 shows the wing (2) with the pressure distribution where the extrados vectors (10) have the resultant (Le) and the intrados vectors (11) the resultant (Li) this of less value than the current wing shown in FIG. 2, thus increasing its lift. In this case the pressure produced at the front of the fuselage, on the leading edges of the wings and horizontal stabilise is sent through ducts to the intrados (13). It is useful independently of the angle of attack. (V) is the ram air.

What is claim is:

1. A process for the recovery of the energy from the air in pressurised areas of aircraft that consists of linking or moving air from the pressurised areas to the lower areas of the fuselage and lower surfaces of the wings, horizontal stabilisers, and other aerodynamic profiles, along ducting and by discharging through multiple slots or openings flowing downward and rearward with a small inclination against the direction of the air flow.

2. A process for the recovery of the energy from the air in pressurised areas of aircraft according to claim 1, wherein at the lower areas of the fuselage a part of the air is discharged into the air by a duct through a check valve and a regulating valve through multiples slots or openings.

3. A process for the recovery of the energy from the air in pressurised areas of aircraft according to claim 1, wherein at the lower surfaces of the wing a part of the air is discharged into the air by a duct through a check valve and a regulating valve through multiples slots or openings.

4. A process for the recovery of the energy from the air in pressurised areas of aircraft according to claim 1, wherein a part of the air conditioning flow is discharged directly through openings or slots without flowing through that valve.

5. A process for the recovery of the energy from the air in pressurised areas of aircraft according to claim 1, wherein are used ducts that link the pressure produced at the front of the fuselage with its lower surface.

6. A process for the recovery of the energy from the air in pressurised areas of aircraft according to claim 1, wherein uses ducts that link the pressure produced on leading edges of the wings and the horizontal stabiliser with its lower surface or intrados.

7. A process for the recovery of the energy from the air in pressurised areas of aircraft according to claim 1, wherein the opening or groove outlets take the form of converging nozzles.
